(19) United States
(12) Patent Application Publication
(10) Pub. No.: US 2025/0030015 A1
(43) Pub. Date: Jan. 23, 2025

(54) DETERMINATION METHOD AND FUEL CELL SYSTEM

(71) Applicant: Robert Bosch GmbH, Stuttgart (DE)

(72) Inventors: Timo Bosch, Renningen (DE); Gregory Rewers, Schwieberdingen (DE); Tobias Falkenau, Esslingen (DE)

(21) Appl. No.: 18/715,183

(22) PCT Filed: Dec. 5, 2022
(86) PCT No.: PCT/EP2022/084338

§ 371 Date: May 31, 2024

(30) Foreign Application Priority Data
Dec. 15, 2021 (DE) 10 2021 214 390.3

(51) Int. Cl. H01M 8/04119; H01M 8/04291; H01M 8/0432; H01M 8/0438; H01M 8/0444; H01M 8/04492; H01M 8/04537; H01M 8/04828; H01M 8/10

(52) U.S. Cl. CPC H01M 8/04164; H01M 8/04126; H01M 8/04291; H01M 8/04358; H01M 8/04388; H01M 8/04447; H01M 8/04455; H01M 8/045; H01M 8/04582; H01M 8/04835; H01M 2008/1095

(57) ABSTRACT

The present invention relates to a determination method (200) for determining a crossover rate (CR) of at least one fuel cell (10) of a fuel cell system (100) for regulation of the fuel cell system (100), the determination method (200) having the following method steps:
detecting (202) fill levels (F) of water (W) in a moisture separator (20) of the fuel cell system (100) by means of a fill level detection device (24),
draining (204) water (W) out of the moisture separator (20) using a drainage device (22) of the moisture separator (20),
measuring (206) a first time (t1) during drainage (204) between a first fill level (F1) and at least a second fill level (F2) of the water (W) in the moisture separator (20),
determining (208) the crossover rate (CR) of the at least one fuel cell (10) from the measured first time (t1) and the at least two measured fill levels (F1, F2) by means of a computer unit (30) of the fuel cell system (100), wherein the crossover rate (CR) corresponds to a transition rate of water (W) from a cathode side (K) of the at least one fuel cell (10) to the anode side (A) of the at least one fuel cell (10).

The invention also relates to a fuel cell system (100) having a plurality of fuel cells (10), a moisture separator (20), a drainage device (22), a fill level detection device (24), and a computer unit (30).

### BACKGROUND

The present invention relates to a determination method for determining a crossover rate of at least one fuel cell of a fuel cell system for regulation of the fuel cell system. Further, the invention relates to a fuel cell system comprising a plurality of fuel cells, a moisture separator, a drainage device, a fill level detection device, and a computer unit, in particular for a motor vehicle.

In the known prior art for polymer electrolyte membrane fuel cell systems, hydrogen is converted into electrical energy by means of oxygen, generating waste heat and water. The conversion of hydrogen is equivalent to hydrogen molecules being consumed and/or removed on the anode side. The fuel cell usually consists of an anode supplied with hydrogen, a cathode supplied with air, and the polymer electrolyte membrane placed between the two. A plurality of such individual fuel cells are stacked in practical application to increase the generated electric voltage. Within this stack, called a fuel cell stack, are supply channels that supply hydrogen and air to the individual cells and remove the depleted moist air as well as the depleted anode exhaust gas.

The anode exhaust gas separated from water, usually still contains hydrogen and is therefore recirculated back to the input of the fuel cell stack. Recirculation is realized according to the prior art, mostly with jet pumps and or gas conveying units. Moisture separators are used to separate liquid water from the gaseous portion of the anode exhaust gas. In addition to the separation function, the moisture separator usually also has the task of storing the separated water. In the prior art, if the accumulator is full, the water is discharged by means of the opening of a so-called drain valve. According to the prior art, fill level sensors are used to detect the fill level of the moisture separator. A disadvantage for the known fuel cells is that this results in at least one sealing point for the fill level sensor for measuring the fill level of the moisture separator.

### SUMMARY

The invention discloses a determination method for determining a crossover rate of at least one fuel cell of a fuel cell system for regulation of the fuel cell system. Further, the invention discloses a fuel cell system comprising a plurality of fuel cells, a moisture separator, a drainage device, a fill level detection device, and a computer unit, in particular for a motor vehicle. In this context, features described in connection with the determination method according to the invention clearly also apply in connection with the fuel cell system according to the invention, and respectively vice versa so that, with respect to the disclosure, mutual reference to the individual aspects of the invention is or can always be made.

According to a first aspect of the invention, the invention discloses a determination method for determining a crossover rate of at least one fuel cell of a fuel cell system for regulation of the fuel cell system, the determination method having the following method steps:
detecting fill levels of water in a moisture separator of the fuel cell system by means of a fill level detection device,
draining water out of the moisture separator using a drainage device of the moisture separator,
measuring a first time during drainage between a first fill level and at least a second fill level of the water in the moisture separator,
determining the crossover rate of the at least one fuel cell from the measured first time and the at least two measured fill levels by means of a computer unit of the fuel cell system, wherein the crossover rate corresponds to a transition rate of water from a cathode side of the at least one fuel cell to the anode side of the at least one fuel cell.

In a fuel cell, water usually passes in liquid form from the cathode to the anode. A water separator downstream of the at least one fuel cell, in particular a fuel cell stack, on the anode side is used to at least partially separate and collect the liquid water from the fluid flow. The moisture separator can be configured such that the separation efficiency is slightly dependent on the amount of liquid water present at the inlet. The separation efficiency is defined as the quotient of separated liquid water divided by the amount of liquid water at the moisture separator inlet. Thus, by way of example, if the amount of water in the moisture separator is known, the amount of water that passes from a cathode side of the at least one fuel cell to the anode side of the at least one fuel cell may be inferred. The crossover rate according to the invention thus corresponds to a transition rate of water from a cathode side of the at least one fuel cell to the anode side of the at least one fuel cell of the fuel cell system.

For better illustration, an example of a water separation cycle is defined from an “empty state” of the moisture separator at the time t_start to a new “empty state” t_end. Between t_start and t_end, the moisture separator is partially filled until the draining process is initiated. The drainage of the water starts at a time to between t_start and t_end, at a filling volume V_0. Water is now discharged until the empty state of the moisture separator has been detected. Time t_end has been reached. Between time to and t_end, the discharged amount of water is determined, for example by means of integration, and a V_discharged_total is obtained. V_discharged_total divided by a known water separation efficiency of the moisture separator results in V_crossover_total. V_crossover_total is made up of the volume V_0 at t0 and the amount of water V_crossover_new separated between t0 and t_end. Viewed differently, however, V_crossover_total corresponds to the crossover amount between t_start and t_end and the average crossover rate valid within a water separation cycle can be determined by dividing V_crossover_total by the water separation cycle time (t_end minus t_start). In the example above, the at least two measured fill levels are thus, by way of example, defined as V_0 for the first fill level and as an empty moisture separator or substantially empty moisture separator for the second fill level. In the context of the invention, the wording “X or substantially X” is understood to mean as low a deviation as possible, e.g., based on manufacturing tolerances, material, and/or process properties, without altering the underlying intended function of the feature.

Preferably, the crossover rate is thus a rate with the unit of amount of water per time. Alternatively or additionally, the crossover rate may be defined as a percentage rate relative to an amount of water in the fuel cell system, to the amount of water input of the fuel cell system, and/or another transition rate of water from a cathode side of the at least one fuel cell to the anode side of the at least one fuel cell. Furthermore, it is advantageous if the determined crossover rate according to the invention is stored, for example in a storage unit and/or control unit of the fuel cell system, wherein provision of the determined crossover rates is enabled for further functions of the fuel cell system and/or a motor vehicle.

The example method sequence described above cannot be used to calculate a real-time crossover rate, but an average crossover rate as described. For example, the averaging horizon corresponds to a water separation cycle of “empty state reached” until “empty state reached” again. However, the at least one fuel cell, in particular a fuel cell stack, from a plurality of fuel cells, and thus the determination method in practice usually has an inertia with regard to determining the crossover rate in the fuel cell system network. However, a determination of the crossover rate in real time is also not absolutely necessary in the context of the invention. Advantageously, however, the time of a cycle for drainage may be reduced and/or triggered more frequently to successively determine the crossover rate more accurately.

The first time according to the invention preferably corresponds to a duration of the method step of draining between a first fill level and at least a second fill level of water in the moisture separator. The first time and the times described below are measured, for example, by the computer unit or a separate measurement unit.

From the known constructive configuration of the moisture separator and at least two detected fill levels, an amount of water that is discharged out of the moisture separator when drained may be determined. In relation to at least one of the measured times, a crossover rate for the at least one fuel cell and/or the fuel cell system may be determined from the determined amount of water.

Unless explicitly stated otherwise, the method steps described hereinabove and hereinafter can be performed individually, together, once, several times, in parallel, and/or consecutively in any order, provided that doing so is technically feasible. A designation, as for example “first method step” and “second method step,” does not require any chronological order and/or prioritization. A preferred order of the method steps provides that the method steps are performed in the order listed.

A determination method configured in this way is particularly advantageous because it enables determining the crossover rate of at least one fuel cell of a fuel cell system for regulation of the fuel cell system by particularly simple and inexpensive means.

According to a preferred further development of the invention, it may be provided in a determination method that the determination method further comprises:
detecting at least one operating pressure, in particular an anode internal pressure, by a pressure detection device, wherein the crossover rate of the at least one fuel cell is determined as a function of the at least one detected operating pressure.

Depending on the operating point of the at least one fuel cell and/or the fuel cell system, there is a different operating pressure of the at least one fuel cell and/or the fuel cell system. For example, the operating pressure depends on which water mass flow is drained out of the moisture separator using the drainage device of the moisture separator. By detecting at least one operating pressure, a further improvement in the accuracy of determining the crossover rate is enabled as at least one detected operating pressure of the at least one fuel cell and/or the fuel cell system is considered for determining the crossover rate of the at least one fuel cell. For example, the operating pressure within the anode and/or in a fuel cell supply line and/or a fuel cell discharge is detected.

According to a preferred further development of the invention, it may be provided in a determination method that the determination method further comprises:
measuring a second time between two method steps of draining, wherein the crossover rate of the at least one fuel cell is determined as a function of the measured second time.

The second time according to the invention is to be understood as the time between two method steps, in particular between two directly consecutive method steps, of the draining. For example, the second time can be measured between the start times, in particular at the detected first fill level or the end times, in particular at the detected second fill level, of the draining. The crossover rate is preferably determined as a function of the measured second time, in particular wherein the time difference between the first time and the second time is considered and/or specified. The difference between the first time and the second time may be understood, by way of example, as the time in which the moisture separator fills from the second fill level to the first fill level. A determination method configured in this way is particularly advantageous because further information and data about the fuel cell system can be determined using simple and inexpensive means and can be used, for example, to adjust the fuel cell system.

According to a preferred further development of the invention, it may be provided in a determination method that the computer unit is connected in a data and/or signal communicative manner to the fill level detection device, the drainage device, and/or the pressure detection device, wherein draining is triggered by the drainage device when the first fill level is detected by the computer unit. A determination method configured in this way is particularly advantageous, as an advantageous automatic system is enabled by the computer unit, wherein draining is triggered by the drainage device when the first fill level is detected by the computer unit. The data-and/or signal-communicative connection between the computer unit of the fill level detection device and/or the drainage device may be wired or configured wirelessly.

According to a preferred further development of the invention, it may be provided in a determination method that the determination method further comprises:
regulating a humidity device of the fuel cell system as a function of the determined crossover rate, wherein the humidity device is configured to add and/or remove humidity into and/or out of the fuel cell system.

Preferably, a humidity device according to the invention is configured to increase and/or decrease the humidity in the at least one fuel cell and/or the at least one fuel cell system. Based on the determined crossover rate, a regulation chain is enabled by the humidity device as an alternative or in addition to the regulation to the measured humidity at the cathode input, which is common in the prior art. The information from the crossover rate about the amount of water at the at least one fuel cell anode side is to be used as an example to regulate the desired fuel cell cathode inlet moisture and thus to adjust the average humidity over the run length of the at least one fuel cell. This regulation is further preferably based on the fact that the at least one fuel cell and/or the fuel cell system was initially sufficiently measured such that a database is available for various operating points of the fuel cell system for determining and/or converting between target moisture at the cathode inlet and anode-side crossover rate. Further influencing factors, which are preferably initially investigated, are multidimensional, but can be carried out on a fuel cell system using, for example, a DOE and/or statistical test planning. Such a configured determination method is particularly advantageous, for example, because a sensor, in particular the moisture sensor at the fuel cell input, is eliminated. Furthermore, the crossover rate determined on the anode side can be used to optimize the piloted operation and to optimize the pilot control as a kind of feedback. According to this embodiment of the determination method, a possible goal can be to achieve a defined crossover rate or to remain within certain limits before the pilot control is engaged.

According to a preferred further development of the invention, it may be provided in a determination method that the humidity device is arranged in a feed fluid path of the cathode side. It represents an advantageous embodiment of the humidity device according to the invention when it is arranged in a supply fluid path of the cathode side, because the air humidity can thus be measured, for example from the supplied air to the at least one fuel cell. Thus, the regulation of the determination method is advantageously improved because the humidity of the fuel cell system is preferably regulated based on the measured humidity in a feed fluid path of the cathode side.

According to a preferred further development of the invention, it may be provided in a determination method that the draining of water out of the moisture separator is time and/or quantity controlled. According to another embodiment, the frequency of draining may be increased manually, automatically, actively, or passively. In particular, the frequency of draining may be increased when the rate of update of water transfer information is needed more often and/or rapid changes in states and/or measured variables are expected at certain operating points of the fuel cell system. Such a determination method is particularly advantageous because a determination method, in particular the frequency of discharge, can be adjusted to various use scenarios and/or operating points of the fuel cell system.

According to a preferred further development of the invention, it may be provided in a determination method that the determination method further comprises:
detecting at least one of the following measured variables by at least one detection sensor of the fuel cell system:
stoichiometry of the anode side,
stoichiometry of the cathode side,
process pressure of the at least one fuel cell and/or the fuel cell system,
process temperature of the at least one fuel cell and/or the fuel cell system,
coolant temperature of the at least one fuel cell and/or the fuel cell system,
moisture of the anode side, in particular an input of the anode side,
moisture of the cathode side, in particular an input of the cathode side,
flow of the at least one fuel cell and/or the fuel cell system.

Detecting at least one of said measured variables by at least one detection sensor of the fuel cell system constitutes an advantageous development of the determination method according to the invention, as the detected data is provided and/or used for the control and/or regulation of the fuel cell system and/or a motor vehicle. Preferably, the at least one detected measured variable is stored, for example, in a storage unit and/or control unit of the fuel cell system, wherein provision of the detected measured variable is enabled for further functions of the fuel cell system and/or a motor vehicle.

According to a preferred further development of the invention, it can be provided in a determination method that the regulation is carried out as a function of at least one of the detected measured variables. In addition to the preceding section, it is advantageous if the humidity device of the fuel cell system is regulated as a function of the determined crossover rate and as a function of at least one of the detected measured variables. The at least one measured variable advantageously allows at least one additional item of information to be considered when regulating the humidity device and thus an improved and/or more precise regulation of the fuel cell system.

According to a second aspect of the invention, the invention discloses a fuel cell system comprising a plurality of fuel cells, a moisture separator, a drainage device, a fill level detection device, and a computer unit. The fuel cell system is configured to perform the determination method according to the first aspect.

The fuel cell system described results in all advantages already described for the determination method according to the first aspect of the invention.

### BRIEF DESCRIPTION OF THE DRAWINGS

The determination method according to the invention and the fuel cell system are explained in greater detail hereinafter with reference to the drawings. Schematically shown are:

FIG. 1 in a side view, a fuel cell system having a fuel cell, a moisture separator, a drainage device, a fill level detection device, and a computer unit,

FIG. 2 in a graph, the water level of the moisture separator of the fuel cell system over time, and

FIG. 3 in a flow chart, a configuration of the determination method according to the invention.

### DETAILED DESCRIPTION

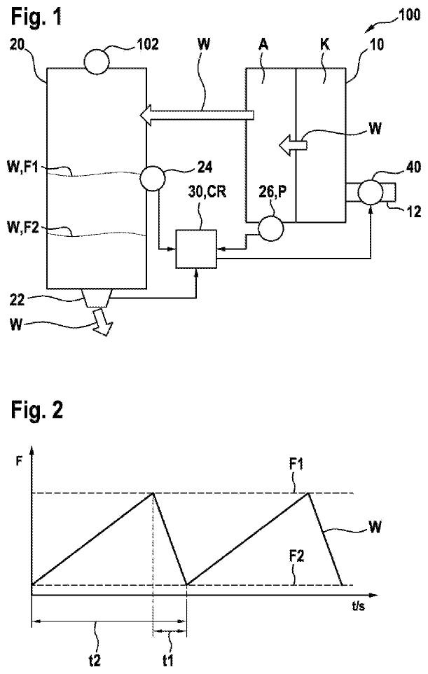

Elements having the same function and mode of action are in each case provided with the same reference signs in FIGS. 1 to 3.

In FIG. 1, a side view schematically shows a fuel cell system 100 having a fuel cell 10, a moisture separator 20, a drainage device 22, a fill level detection device 24, and a computer unit 30. The fill level detection device 24 is configured to detect fill levels F of water W in the moisture separator 20 of the fuel cell system 100. The drainage device 22 is configured to drain water W from the moisture separator 20. The computer unit 30 is configured to determine the crossover rate CR of the one fuel cell 10 from the measured first time and the two measured fill levels F1, F2, wherein the crossover rate CR corresponds to a transition rate of water W from a cathode side K of the one fuel cell 10 to the anode side A of the one fuel cell 10. The pressure detection device 26 is configured to detect an operating pressure P, here an internal anode pressure, wherein the crossover rate CR of the one fuel cell 10 is determined as a function of the at least one detected operating pressure P. The computer unit 30 is connected in a data-and signal-communicative manner to the fill level detection device 24, the drainage device 22, and the pressure detection device 26, wherein the draining is triggered by the drainage device 22 when the first fill level F1 is detected by the computer unit 30. Furthermore, a humidity device 40 of the fuel cell system 100 is regulated as a function of the determined crossover rate CR, wherein the humidity device 40 is configured to add and/or remove humidity into and/or out of the fuel cell system 100. The humidity device 40 is arranged in a feed fluid path 12 of the cathode side K. A drainage of the water W out of the water separator 20 is time and volume controlled. Furthermore, the fuel cell system 100 comprises a detection sensor 102, wherein the detection sensor 102 is configured to detect at least one measured variable of the fuel cell system.

FIG. 2 schematically shows a chart of the fill level F of the water W in the moisture separator 20 (not shown) of the fuel cell system 100 (not shown) over time t. A first time t1 during draining between a first fill level F1 and a second fill level F2 of the water W in the moisture separator 20. Furthermore, a second time t2 between two method steps of draining are measured, wherein the crossover rate of the at least one fuel cell 10 (not shown) are determined as a function of the measured second times t1, t2.

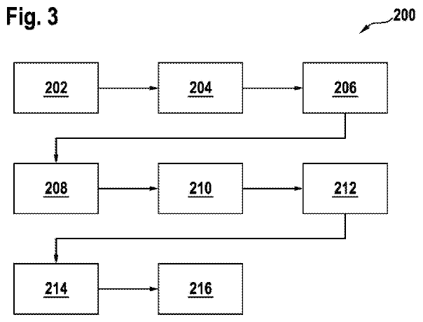

FIG. 3 schematically shows in a flow chart a configuration of the determination method 200 according to the invention. For improved clarity, only the reference numerals of the method steps are provided in FIG. 3. The determination method 200, in a first method step, comprises detecting 202 fill levels F of water W in a moisture separator 20 of the fuel cell system 100 by means of a fill level detection device 24. The determination method 200, in further method step, comprises the drainage 204 of water W from the moisture separator 20 with a drainage device 22 of the moisture separator 20. The determination method 200, in a first method step, comprises measuring 206 a first time t1 during drainage 204 between a first fill level F1 and at least a second fill level F2 of the water W in the moisture separator 20. In a first method step, the determination method 200 comprises determining 208 the crossover rate CR of the at least one fuel cell 10 from the measured first time t1 and the at least two measured fill levels F1, F2 by means of a computer unit 30 of the fuel cell system 100, wherein the crossover rate CR corresponds to a transition rate of water W from a cathode side K of the at least one fuel cell 10 to the anode side A of the at least one fuel cell 10. The determination method 200 in a first method step comprises detecting 210 at least one operating pressure P by a pressure detection device 26, wherein the crossover rate CR of the at least one fuel cell 10 is determined 208 as a function of the at least one detected operating pressure P. The determination method 200 comprises measuring 212 a second time t2 between two method steps of draining 204 in a first method step, wherein the crossover rate CR of the at least one fuel cell 10 is determined 208 as a function of the measured second time t2. The determination method 200 comprises regulating 214 a humidity device 40 of the fuel cell system 100 as a function of the determined crossover rate CR in a first method step, wherein the humidity device 40 is configured to add and/or remove humidity into and/or out of the fuel cell system 100. The determination method 200 comprises detecting 216 at least one of the following measured variables by at least one detecting sensor 102 of the fuel cell system 100 in a first method step:
stoichiometry of the anode side A,
stoichiometry of the cathode side K,
process pressure of the at least one fuel cell 10 and/or the fuel cell system 100,
process temperature of the at least one fuel cell 10 and/or the fuel cell system 100,
coolant temperature of the at least one fuel cell 10 and/or the fuel cell system 100,
moisture of the anode side A, in particular an input of the anode side A,
moisture of the cathode side K, in particular an input of the cathode side K,
flow of the at least one fuel cell 10 and/or the fuel cell system 100.

1. A determination method (200) for determining a crossover rate (CR) of at least one fuel cell (10) of a fuel cell system (100) for regulation of the fuel cell system (100), the determination method (200) comprising the following method steps:
detecting (202) fill levels (F) of water (W) in a moisture separator (20) of the fuel cell system (100) by means of a fill level detection device (24),
draining (204) water (W) out of the moisture separator (20) using a drainage device (22) of the moisture separator (20),
measuring (206) a first time (t1) during drainage (204) between a first fill level (F1) and at least a second fill level (F2) of the water (W) in the moisture separator (20),
determining (208) the crossover rate (CR) of the at least one fuel cell (10) from the measured first time (t1) and the at least two measured fill levels (F1, F2) by means of a computer unit (30) of the fuel cell system (100), wherein the crossover rate (CR) corresponds to a transition rate of water (W) from a cathode side (K) of the at least one fuel cell (10) to the anode side (A) of the at least one fuel cell (10).

2. The determination method (200) according to claim 1,
wherein
the determination method (200) further comprises:
detecting (210) at least one operating pressure (P), in particular an anode internal pressure, by a pressure detection device (26), wherein the crossover rate (CR) of the at least one fuel cell (10) is determined (208) as a function of the at least one detected operating pressure (P).

3. A determination method (200) according to claim 1,
wherein
the determination method (200) further comprises:
measuring (212) a second time (t2) between two method steps of draining (204), wherein the crossover rate (CR) of the at least one fuel cell (10) is determined (208) as a function of the measured second time (t2).

4. A determination method (200) according to claim 1,
wherein
the computer unit (30) is connected in a data-and/or signal-communicative manner to the fill level detection device (24), the drainage device (22), and/or the pressure detection device (26), wherein draining (204) is triggered by the drainage device (22) when the first fill level (F1) is detected (202) by the computer unit (30).

5. A determination method (200) according to claim 1,
wherein
the determination method (200) further comprises:
regulating (214) a humidity device (40) of the fuel cell system (100) as a function of the determined crossover rate (CR), wherein the humidity device (40) is configured to add and/or remove humidity into and/or out of the fuel cell system (100).

6. The determination method (200) according to claim 5,
wherein
the humidity device (40) is arranged in a feed fluid path (12) of the cathode side (K).

7. A determination method (200) according to claim 1,
wherein
the drainage (204) of water (W) out of the moisture separator (20) is time and/or quantity controlled.

8. A determination method (200) according to claim 1,
wherein
the determination method (200) further comprises:
detecting (216) at least one of the following measured variables by at least one detection sensor (102) of the fuel cell system (100):
stoichiometry of the anode side (A),
stoichiometry of the cathode side (K),
process pressure of the at least one fuel cell (10) and/or the fuel cell system (100),
process temperature of the at least one fuel cell (10) and/or the fuel cell system (100),
coolant temperature of the at least one fuel cell (10) and/or the fuel cell system (100),
moisture of the anode side (A), in particular an input of the anode side (A),
moisture of the cathode side (K), in particular an input of the cathode side (K), or
flow of the at least one fuel cell (10) and/or the fuel cell system (100).

9. The determination method (200) according to claim 8,
wherein
regulating (214) occurs as a function of at least one of the detected measured variables.

10. A fuel cell system (100) comprising a plurality of fuel cells (10), a moisture separator (20), a drainage device (22), a fill level detection device (24), and a computer unit (30),
wherein
the fuel cell system (100) is configured to perform the determination method (200) of any preceding claim.
